(19) United States
(12) Patent Application Publication
(10) Pub. No.: US 2010/0155262 A1
(43) Pub. Date: Jun. 24, 2010

(54) APPARATUS AND METHOD TO MEASURE ELECTROCHEMICAL IMPEDANCE

(76) Inventors: Omar J. Yepez, Stillwater, OK (US); Bruce B. Randolph, Bartlesville, OK (US); Xiaoyi Gong, Bartlesville, OK (US)

Correspondence Address: ConocoPhillips Company - IP Services Group;Attention: DOCKETING, 600 N. Dairy Ashford, Bldg. MA-1135, Houston, TX, 77079, US

(21) Appl. No.: 12/338,061

(22) Filed: Dec. 18, 2008

(51) Int. Cl. G01N 17/04; C25B 9/00

(52) U.S. Cl. 205/775.5; 204/242

(57) ABSTRACT

An electrochemical cell apparatus and method comprising a first electrode and a second electrode wherein the area ratio between them is 15 or higher, for example a metal plate and a metal wire; wherein said first and second electrodes are made from the same material; and wherein the distance between said first electrode and said second electrode is in the range of from about 1 mm to about 1 μm is provided. Such electrochemical cell can be used to measure crude oil corrosion using an electrochemical impedance method.

### BACKGROUND OF THE INVENTION

1. Field of the Invention

The present invention relates generally to corrosion measurement.

2. Description of the Prior Art

The naphthenic acid corrosion phenomenon is a facility maintenance concern and restricts the freedom of crude oil selection for refinery runs and limits profit margins. Naphthenic acid corrosion suffers from a reliability problem in refinery distillation units, as well as a shortage of accurate assessment methods. Existing methods are laborious and time consuming. Refiners need a quick response time and therefore must rely on indirect and frequently inaccurate indicators of corrosion. Examples of two frequently inaccurate indicators of corrosion are the total acid number (TAN) and the sulfur content of the oil. Although the TAN value of the oil alone does not reliably assess naphthenic acid corrosion issues in a refinery, it is still used today because it is easily measured and crude oil with higher TAN values is perceived as corrosive. While this is generally the case, it is not always true.

Today, the most common method to determine corrosion rates is still the coupon weight loss method. The coupon weight loss method measures the weight difference in corrosion coupons of the material of interest. Such coupons are allowed to corrode in an oil sample and at high temperatures. The difference between the weights of the coupon before and after exposure can be used to determine a corrosion rate. However, there are drawbacks with this method. Due to the typical corrosion rates that characterize naphthenic acid corrosion, such experiments need long run times (3 days or more), just to produce one corrosion rate measurement. These long experimental run times raise concerns about the thermal integrity of the oil. The high scatter often associated with naphthenic corrosion data obtained also supports such concerns, and makes this weight loss method impractical for many applications. In addition, in a refinery setting, corrosion flow loops with coupons are often left in place for long periods (i.e., 30 days) before removal and analysis. During the exposure period there is no corrosion information available. Therefore, there is a need for more reliable and faster methods to measure naphthenic acid corrosion, before the feed can damage a distillation unit.

Electrochemical impedance has been used to measure corrosion of different materials in aqueous systems, in concrete, in coated materials and it has been used to effectively measure the electrical resistance of transformer oils. However, electrochemical impedance has never been demonstrated to effectively measure corrosion in crude oil or in refined hydrocarbons.

### SUMMARY OF THE INVENTION

In one embodiment of the present invention, there is provided an electrochemical cell apparatus comprising a first electrode and a second electrode are made from the same composition and the area of said first electrode is at least 10 times larger than the area of said second electrode.

In another embodiment of the present invention, there is provided a method to determine corrosion rate in real time. The method of this embodiment comprises the steps of: a) creating an electrochemical cell comprising a first electrode and a second electrode wherein the area of said first electrode is at least 10 times larger than the area of said second electrode; b) generating an electrochemical impedance spectrum from said electrochemical cell; c) using an equivalent circuit having a Warburg element and a resistance to the charge transfer of the corrosion process wherein said Warburg element is in parallel with said resistance to the charge transfer of the corrosion process; and d) obtaining the inverse of the resistance to the charge transfer of the corrosion process to calculate the corrosion rate of a metal used in the electrochemical cell.

### BRIEF DESCRIPTION OF THE DRAWING FIGURES

A preferred embodiment of the present invention is described in detail below with reference to the attached drawing figures, wherein:

FIG. 1 is a schematic illustration of an electrochemical cell;

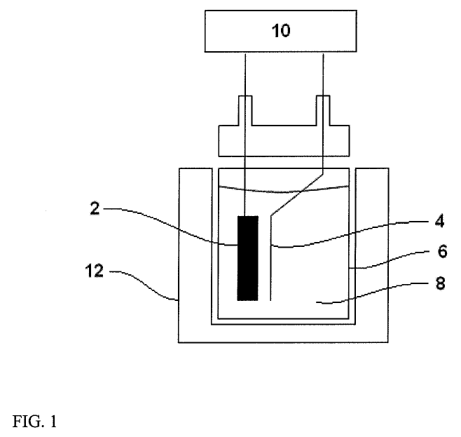

FIG. 2 is a Nyquist plot of the experimental data of the impedance response of the 0.25 mm iron wire over 3 days;

FIG. 3 is an inventive equivalent circuit used to interpret the experimental data in FIG. 2; and

FIG. 4 is contains replicas of experiments at four (4) different total acid numbers (TAN), at 250° C.

### DETAILED DESCRIPTION

In accordance with this invention, there is provided an electrochemical cell apparatus comprising at least two electrodes. A first electrode 2, can be used both as a counter and a reference electrode, and comprises a large surface area, such as, for example a large, flat surface, such as for example, a plate. A second electrode 4, can be used as a working electrode, and comprises a small surface area, such as, for example, a small diameter wire, in the range of 0.25 mm diameter or lower. Both electrodes 2 and 4 must be made of the same composition. Exemplary compositions for electrodes 2 and 4 are selected from the group consisting of iron, 5 percent chromium stainless steel, 316 stainless steel, carbon steel, and/or any iron base alloy and/or any copper base alloy. Preferably, for ease of use, iron is used to make both electrodes 2 and 4.

The area ratio of the surfaces between electrodes 2 and 4 must be significant. Preferably, the surface area of electrode 2 must be at least about 10 times larger than the surface area of electrode 4, preferably about 25 times larger than electrode 4. Most preferably, for best results, the surface area of electrode 2 is at least 30 times to 300 times larger than the surface area of electrode 4.

Additionally, the distance between electrodes 2 and 4 needs to be very small. Usually, electrodes 2 and 4 are less than or equal to 1 mm apart, preferably less than or equal to 0.1 mm apart. Most preferably, electrodes 2 and 4 are less than or equal to 0.05 mm to 0.001 mm (0.1 μ) apart for best determination of impedance. However, although not preferred, greater distances can be used but a more sensitive measuring device, such as, for example, a potentiostat, should be more sensitive. Additionally, electrodes 2 and 4 can be closer together than 0.1 micron (i), provided there is no physical contact between electrodes 2 and 4.

Electrodes 2 and 4 are submerged in vessel 6, which holds liquid 8, wherein liquid 8 has a very low conductivity, typically that of the crude oil, crude oil distillates, or mineral oil. Vessel 6, which holds liquid 8, also can be called a low-conductive environment. Electrodes 2 and 4 are connected to potentiostat 10, wherein potentiostat 10 can be used to measure impedance signals between electrodes 2 and 4.

Optionally, jacket 12 and be used to heat vessel 6 which holds liquid 8.

The electric resistance of a circuit element can depend on its area. As the cross section of any circuit element decreases, the resistance of such circuit element increases. Impedance is a general resistance that measures the electric resistance (which does not depend on the frequency of the voltage perturbation applied), plus the reactance (which does depend on the frequency of the voltage perturbation applied). Thus, while not wishing to be bound by theory, it is believed that impedance also depends on the area of the electrodes. Therefore, in order to measure corrosion in crude oil or refined products, a very large area ratio between electrodes 2 and 4 must be present. In such a way, the impedance of the smaller area electrode is maximized over the higher area electrode, and useful electrochemical information can be extracted from the smaller electrode.

### EXAMPLES

An iron plate having the dimensions of 5 cm by 2.5 cm by 4 mm, thus having an electrode area of 12.5 cm², was facing a 0.25 mm diameter iron wire that is 5 cm long, having an area of 0.39 cm². Both electrodes were made from 99.5% pure iron from Goodfellow Corporation. The two electrodes, one an iron plate and the other an iron wire, were separated by a 0.05 mm gap made with a Kapton® polyamide film gasket. The polyamide gasket had a high electrical insulation and a very low expansion coefficient so that the gap and the electrical insulation between the two electrodes was constant during the experiment. The iron plate was embedded in a ceramic frame which also held the polyamide gasket and the iron wire to make an “electrode sandwich.” Prior to use, any rust inhibitor coating on the iron wire was removed and the wire was stored in mineral oil to prevent air or moisture corrosion.

Various naphthenic acid (purchased commercially from Fluka, a division of Sigma Aldrich, Inc.) solutions were prepared in mineral oil (purchased commercially from Sigma Aldrich, Inc.).

The ceramic frame with the electrode sandwich was submerged into the different naphthenic acid/mineral oil solutions to be tested and the cell was sealed. All runs were conducted at 250° C. Impedance measurements were taken hourly for three (3) days. The potentiostat imposed a sinusoidal voltage perturbation of 500 mV across the electrodes at several frequencies and measured the corresponding sinusoidal current. The current responses were analyzed in terms of its magnitude and phase with respect to the voltage perturbation.

Both electrodes were connected to the potentiostat in a two electrode mode and the iron plate was selected as the reference electrode.

The cell was purged with nitrogen and the electrodes were connected to the potentiostat, heating was started and the impedance spectroscopy measurement also commenced. The working temperature was set to 250° C. for all experiments and was constant during all experimental time. Every hour for three days, a frequency sweep from 100,000 to 10 Hz was applied to the electrodes. The potentiostat had the ability to measure impedances as high as 10¹² ohms was used. Then, the impedance spectra were adjusted to the inventive equivalent circuit.

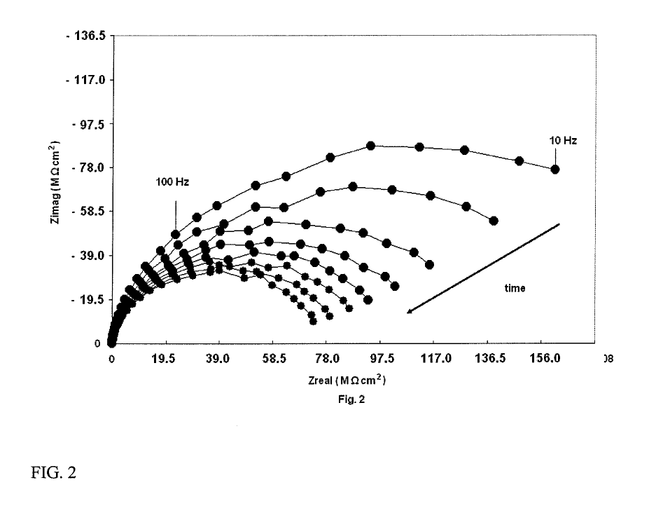

FIG. 2 shows the Nyquist plot of the three-day impedance response of the 0.25 mm iron wire in a naphthenic acid solution with a total acid number (TAN) of 5 at 250° C. The x-axis is real impedance (“Zreal”) in Mohms cm² (MΩ cm²) and the y-axis is imaginary impendence (“Zimag”) in Mohms cm (MΩ cm²). A depressed semi-circle with reduced impedance as time passed is clearly observed.

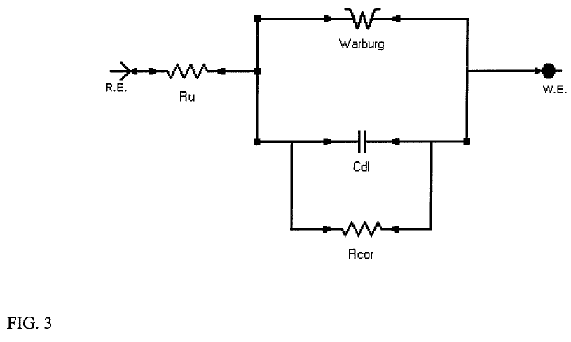

In order to interpret the impedance responses shown in FIG. 2, an inventive equivalent circuit was created and used. The equivalent circuit is the electrical analog to the interfacial processes happening on the electrode surface. The inventive equivalent circuit was designed empirically, i.e., by trial and error, and is shown in FIG. 3. Each component of the equivalent circuit was related to a specific interfacial process. The electrical resistance of the oil (naphthenic acid/mineral oil solution) between wire and plate relates to Ru, the resistance to the charge transfer of the naphthenic acid corrosion process relates to R_{cor}, and the capacitance of the electrochemical double layer is related to C_{dl}. A Warburg diffusion element in parallel to R_{cor}, which usually is not found in electrochemical corrosion mechanisms, also was incorporated. While not wishing to be bound by theory, it is believed that the Warburg diffusion element suggests that a diffusion process can be occurring on the surface of the electrode.

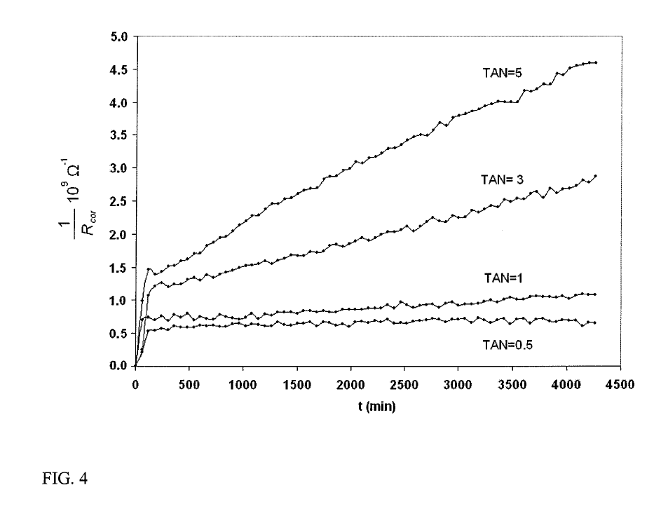

The experimental data at each hourly point (a total of 72 spectra, 1 for each hour) was fitted to the inventive equivalent circuit. Once these simulations were achieved, the electrochemical information provided by the inventive equivalent circuit was obtained. FIG. 4 shows the inverse of the resistance to the charge transfer of the naphthenic acid corrosion process (1/R_{cor}) for different concentrations of naphthenic acid in mineral oil (i.e., different TAN values). This was and is related directly to corrosion rate.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds).

### Definitions

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “including,” “includes,” and “include” have the same open-ended meaning as “comprising,” “comprises,” and “comprise.”

As used herein, the terms “having,” “has,” and “have” have the same open-ended meaning as “comprising,” “comprises,” and “comprise.”

As used herein, the terms “containing,” “contains,” and “contain” have the same open-ended meaning as “comprising,” “comprises,” and “comprise.”

As used herein, the terms “a,” “an,” “the,” and “said” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

### Claims not Limited to the Disclosed Embodiments

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

That which is claimed:

1. An electrochemical cell apparatus comprising a first electrode and a second electrode wherein said first electrode and said second electrode are made from the same composition and the area said first electrode is at least 10 times larger than the area of said second electrode.

2. The apparatus of claim 1 wherein the composition of said first electrode and said second electrode is selected from the group consisting of iron, iron base alloy, copper base alloy, 5% chromium stainless steel, 316 stainless steel, carbon steel, stainless steel 400 series, stainless steel 300 series, and groups consisting of two or more thereof.

3. The apparatus of claim 1 wherein said metal is iron.

4. The apparatus of claim 1 wherein the distance between said first electrode and said second electrode is in a range of from about 1 millimeter to about 0.1 micron.

5. The apparatus of claim 1 wherein said first electrode comprises a flat surface.

6. The apparatus of claim 1 wherein said second electrode comprises a wire.

7. The apparatus of claim 1 wherein said cell further comprises a means to measure electrochemical responses.

8. The apparatus of claim 1 wherein said cell measures an electrochemical response in a low-conductive environment.

9. The apparatus of claim 1 wherein said cell measures an electrochemical response in mineral oil.

10. A method to determine corrosion rate comprising the steps of: a) creating an electrochemical cell comprising a first electrode and a second electrode wherein the area of said first electrode is at least 10 times larger than the area of said second electrode; b) generating an electrochemical impedance spectrum from said electrochemical cell; c) using an equivalent circuit having a Warburg element and a resistance to the charge transfer of the corrosion process wherein said Warburg element is in parallel with said resistance to the charge transfer of the corrosion process; and d) obtaining the inverse of the resistance to the charge transfer of the corrosion process to calculate the corrosion rate of a metal used in the electrochemical cell.

11. The method of claim 10 wherein the composition of said first electrode and said second electrode is selected from the group consisting of iron, iron base alloy, copper base alloy, 5% chromium stainless steel, 316 stainless steel, carbon steel, stainless steel 400 series, stainless steel 300 series, and groups consisting of two or more thereof.

12. The method of claim 10 wherein said metal is iron.

13. The method of claim 10 wherein the distance between said first electrode and said second electrode is in a range of from about 1 millimeter to about 0.1 micron.

14. The method of claim 10 wherein said first electrode comprises a flat surface.

15. The method of claim 10 wherein said second electrode comprises a wire.

16. The method of claim 10 wherein said cell further comprises a means to measure electrochemical responses.

17. The method of claim 10 wherein said cell measures an electrochemical response in a low-conductive environment.

18. The method of claim 10 wherein said cell measures an electrochemical response in mineral oil.

19. A method to determine corrosion rate using an equivalent circuit comprising a Warburg element and a resistance to the charge transfer of the corrosion process, wherein said Warburg element is in parallel with said resistance to the charge transfer of the corrosion process.
